(19) United States
(12) Patent Application Publication
(10) Pub. No.: US 2023/0386049 A1
(43) Pub. Date: Nov. 30, 2023

(54) TRACKING APPARATUS, TRACKING SYSTEM, TRACKING METHOD, AND RECORDING MEDIUM

(71) Applicant: NEC Corporation, Tokyo (JP)

(72) Inventor: Noboru YOSHIDA, Tokyo (JP)

(73) Assignee: NEC Corporation, Tokyo (JP)

(21) Appl. No.: 18/031,710

(22) PCT Filed: Oct. 26, 2020
(86) PCT No.: PCT/JP2020/040031

§ 371 Date: Apr. 13, 2023

(51) Int. Cl. G06T 7/20; G06T 7/73; G06V 20/52

(52) U.S. Cl. CPC G06T 7/20; G06T 7/73; G06V 20/52; G06V 2201/07; G06T 2207/20044

(57) ABSTRACT

A tracking apparatus that includes a detection unit that detects a tracked target from at least two frames constituting video data; an extraction unit that extracts at least one key point from the tracked target having been detected, a posture information generation unit that generates posture information of the tracked target based on the at least one key point, and a tracking unit that tracks the tracked target based on a position and an orientation of the posture information of the tracked target detected from each of the at least two frames.

### TECHNICAL FIELD

The present disclosure relates to a tracking apparatus and the like that track a tracked target in a video.

### BACKGROUND ART

The person tracking technology is a technology for detecting a person from an image frame (hereinafter, also called a frame) constituting a video captured by a surveillance camera or the like and tracking the detected person in the video. In the person tracking technology, for example, each detected person is identified by face authentication or the like, an identification number is given, and the person given the identification number is tracked in the video.

PTL 1 discloses an attitude estimation device that estimates a three-dimensional attitude based on a two-dimensional joint position. The device of PTL 1 calculates from an input image a feature amount in a position candidate of a tracked target, and estimates the position of the tracked target based on the weight of similarity obtained as a result of comparing the feature amount with template data. The device of PTL 1 sets the position candidate of the tracked target based on the weight of similarity and three-dimensional operation model data. The device of PTL 1 tracks the position of the tracked target by repeating, a plurality of times, estimation of the position of the tracked target and setting of the position candidate of the tracked target. The device of PTL 1 estimates a three-dimensional attitude of an attitude estimation target by referring to estimation information of the position of the tracked target and the three-dimensional operation model data.

PTL 2 discloses an image processing apparatus that identifies a person from an image. The apparatus of PTL 2 collates a person in an input image with a registered person based on an attitude similarity between the attitude of the person in the input image and the attitude of the person in a reference image, the feature quantity of the input image, and the feature quantity of the reference image for each person.

NPL 1 discloses a technology for tracking postures of a plurality of persons included in a video. The method of NPL 1 includes sampling a pair of posture estimation values from different frames of a video, and performing binary classification whether a certain pose temporally follows another pose. Furthermore, the method of NPL 1 includes improving the posture estimation method using a key point adjustment method that does not use a parameter.

NPL 2 discloses a related technology for estimating skeletons of a plurality of persons in a two-dimensional image. The technology of NPL 2 includes estimating skeletons of a plurality of persons shown in a two-dimensional image using a method called Part Affinity Fields.

### CITATION LIST

### Patent Literature

PTL 1: JP 2013-092876 A

PTL 2: JP 2017-097549 A

### Non Patent Literature

NPL 1: Michael Snower, Asim Kadav, Farley Lai, Hans Peter Graf, “15 Keypoints Is All You Need”, Proceedings of the IEEE/CVF Conference on Computer Vision and Pattern Recognition (CVPR), 2020, pp. 6738-6748. [NPL 2] Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, pp. 7291-7299.

### SUMMARY OF INVENTION

### Technical Problem

The method of PTL 1 enables to estimate a three-dimensional posture from information regarding a two-dimensional joint position of one person, but does not enable to estimate three-dimensional postures of a plurality of persons. The method of PTL 1 does not enable to determinate whether persons in different frames are the same person based on the estimated three-dimensional posture, and does not enable to track a person between frames.

The method of PTL 2 includes registering a person based on similarity with a feature amount of a reference image for each posture of each person registered in advance regarding an estimated posture. Therefore, the method of PTL 2 does not enable to track a person based on the posture unless the reference image for each posture of each person is stored in a database.

The method of NPL 1 includes performing posture tracking using deep learning, tracking accuracy depends on learning data. Therefore, the method of NPL 1 does not enable to continue tracking based on the posture of the tracked target, in a case where conditions such as the congestion degree, the angle of view, the distance between the camera and the person, and the frame rate are different from the learned conditions.

An object of the present disclosure is to provide a tracking apparatus that can track a plurality of tracked targets based on postures in a plurality of frames constituting a video.

### Solution to Problem

A tracking apparatus of one aspect of the present disclosure includes: a detection unit that detects a tracked target from at least two frames constituting video data; an extraction unit that extracts at least one key point from the tracked target having been detected; a posture information generation unit that generates posture information of the tracked target based on the at least one key point; and a tracking unit that tracks the tracked target based on a position and an orientation of the posture information of the tracked target detected from each of the at least two frames.

In a tracking method of one aspect of the present disclosure, a computer detects a tracked target from at least two frames constituting video data, extracts at least one key point from the tracked target having been detected, generates posture information of the tracked target based on the at least one key point, and tracks the tracked target based on a position and an orientation of the posture information of the tracked target detected from each of the at least two frames.

A program of one aspect of the present disclosure causes a computer to execute processing of detecting a tracked target from at least two frames constituting video data, processing of extracting at least one key point from the tracked target having been detected, processing of generating posture information of the tracked target based on the at least one key point, and processing of tracking the tracked target based on a position and an orientation of the posture information of the tracked target detected from each of the at least two frames.

### Advantageous Effects of Invention

According to the present disclosure, it is possible to provide a tracking apparatus that can track a plurality of tracked targets based on postures in a plurality of frames constituting a video.

### BRIEF DESCRIPTION OF DRAWINGS

FIG. 1 is a block diagram illustrating an example of a configuration of a tracking system according to a first example embodiment.

FIG. 2 is a conceptual diagram for explaining an example of a key point extracted by a tracking apparatus of the tracking system according to the first example embodiment.

FIG. 3 is a conceptual diagram for explaining tracking processing by the tracking apparatus of the tracking system according to the first example embodiment.

FIG. 4 is a table illustrating an example of scores used for tracking of a tracked target by the tracking apparatus of the tracking system according to the first example embodiment.

FIG. 5 is a flowchart for explaining an example of an outline of operation of the tracking system according to the first example embodiment.

FIG. 6 is a flowchart for explaining an example of tracking processing by the tracking apparatus of the tracking system according to the first example embodiment.

FIG. 7 is a block diagram illustrating an example of a configuration of a tracking system according to a second example embodiment.

FIG. 8 is a conceptual diagram for explaining an example of a skeleton line extracted by a tracking apparatus of the tracking system according to the second example embodiment.

FIG. 9 is a flowchart for explaining an example of tracking processing by the tracking apparatus of the tracking system according to the second example embodiment.

FIG. 10 is a block diagram illustrating an example of a configuration of a tracking system according to a third example embodiment.

FIG. 11 is a block diagram illustrating an example of a configuration of a terminal apparatus of the tracking system according to the third example embodiment.

FIG. 12 is a conceptual diagram illustrating an example in which a tracking apparatus of the tracking system according to the third example embodiment causes a screen of display equipment to display display information including an image for adjusting weights of a position and an orientation used for tracking of a tracked target.

FIG. 13 is a conceptual diagram illustrating an example in which the tracking apparatus of the tracking system according to the third example embodiment causes the screen of the display equipment to display display information including an image for adjusting weights of a position and an orientation used for tracking of a tracked target.

FIG. 14 is a conceptual diagram illustrating an example in which the tracking apparatus of the tracking system according to the third example embodiment causes the screen of the display equipment to display display information including an image for adjusting weights of a position and an orientation used for tracking of a tracked target.

FIG. 15 is a conceptual diagram illustrating an example in which the tracking apparatus of the tracking system according to the third example embodiment causes the screen of the display equipment to display display information including an image for adjusting designation of a key point used for generation of posture information.

FIG. 16 is a conceptual diagram illustrating an example in which the tracking apparatus of the tracking system according to the third example embodiment causes the screen of the display equipment to display display information including an image for adjusting designation of a key point used for generation of posture information.

FIG. 17 is a conceptual diagram illustrating an example in which the tracking apparatus of the tracking system according to the third example embodiment causes the screen of the display equipment to display display information including an image for adjusting weights of a position and an orientation used for tracking of a tracked target.

FIG. 18 is a flowchart illustrating an example of processing in which the tracking apparatus of the tracking system according to the third example embodiment receives a setting via a terminal apparatus.

FIG. 19 is a block diagram illustrating an example of a configuration of a tracking apparatus according to a fourth example embodiment.

FIG. 20 is a block diagram illustrating an example of a hardware configuration that achieves the tracking apparatus according to each example embodiment.

### EXAMPLE EMBODIMENT

Example embodiments for carrying out the present invention will be described below with reference to the drawings. However, the example embodiments described below have technically desirable limitations for carrying out the present invention, but the scope of the invention is not limited to the following. In all the drawings used in the description of the example embodiments below, similar parts are given the same reference signs unless there is a particular reason. In the following example embodiments, repeated description regarding similar configurations and operations may be omitted.

### First Example Embodiment

First, the tracking system according to the first example embodiment will be described with reference to the drawings. The tracking system of the present example embodiment detects a tracked target such as a person from image frames (also called frames) constituting a moving image captured by a surveillance camera or the like, and tracks the detected tracked target between frames. The tracked target of the tracking system of the present example embodiment is not particularly limited. For example, the tracking system of the present example embodiment may track not only a person but also an animal such as a dog or a cat, a moving object such as an automobile, a bicycle, or a robot, a discretionary object, or the like as a tracked target. Hereinafter, an example of tracking a person in a video will be described.

### Configuration

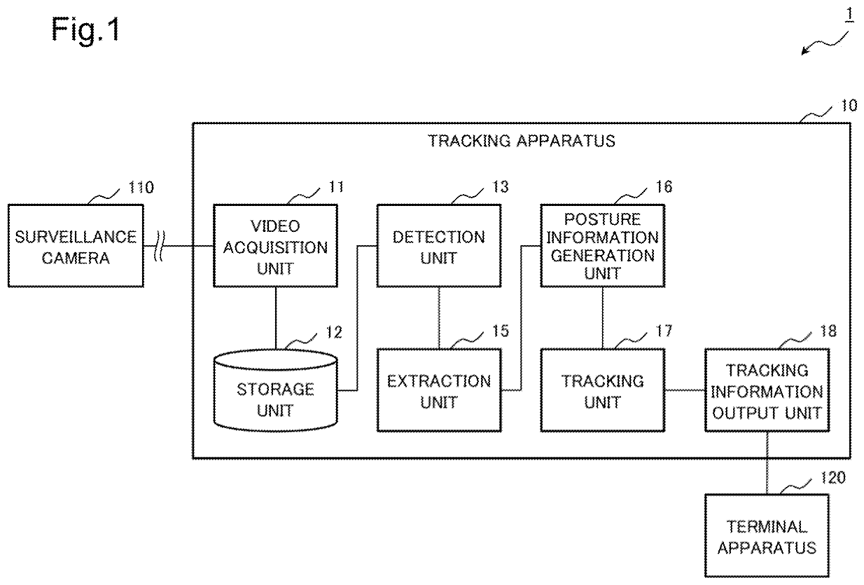

FIG. 1 is a block diagram illustrating an example of the configuration of a tracking system 1 of the present example embodiment. The tracking system 1 includes a tracking apparatus 10, a surveillance camera 110, and a terminal apparatus 120. Although only one surveillance camera 110 and one terminal apparatus 320 are illustrated in FIG. 1, a plurality of surveillance cameras 110 and a plurality of terminal apparatuses 120 may be provided.

The surveillance camera 110 is disposed at a position where an image of a surveillance target range can be captured. The surveillance camera 110 has a function of a general surveillance camera. The surveillance camera 110 may be a camera sensitive to a visible region or an infrared camera sensitive to an infrared region. For example, the surveillance camera 110 is disposed on a street or in a room where persons are present. A connection method between the surveillance camera 110 and the tracking apparatus 10 is not particularly limited. For example, the surveillance camera 110 is connected to the tracking apparatus 10 via a network such as the Internet or an intranet. The surveillance camera 110 may be connected to the tracking apparatus 10 by a cable or the like.

The surveillance camera 110 captures an image of the surveillance target range at a set capture interval, and generates video data. The surveillance camera 110 outputs generated video data to the tracking apparatus 10. The video data includes a plurality of frames whose image is captured at set capture intervals. For example, the surveillance camera 110 may output video data including a plurality of frames to the tracking apparatus 10, or may output each of the plurality of frames to the tracking apparatus 10 in chronological order of capturing. The timing at which the surveillance camera 110 outputs data to the tracking apparatus 10 is not particularly limited.

The tracking apparatus 10 includes a video acquisition unit 11, a storage unit 12, a detection unit 13, an extraction unit 15, a posture information generation unit 16, a tracking unit 17, and a tracking information output unit 18. For example, the tracking apparatus 10 is disposed on a server or a cloud. For example, the tracking apparatus 10 may be provided as an application installed in the terminal apparatus 120.

In the present example embodiment, the tracking apparatus 10 tracks the tracked target between two verification target frames (hereinafter, called a verification frame). A verification frame that precedes in chronological order is called a preceding frame, and a verification frame that follows is called a subsequent frame. The tracking apparatus 10 tracks the tracked target between frames by collating the tracked target included in the preceding frame with the tracked target included in the subsequent frame. The preceding frame and the subsequent frame may be consecutive frames or may be separated by several frames.

The video acquisition unit 11 acquires, from the surveillance camera 110, processing target video data. The video acquisition unit 11 stores the acquired video data in the storage unit 12. The timing at which the tracking apparatus 10 acquires data from the surveillance camera 110 is not particularly limited. For example, the video acquisition unit 11 may acquire the video data including a plurality of frames from the surveillance camera 110, or may acquire each of the plurality of frames from the surveillance camera 110 in the capturing order. The video acquisition unit 11 may acquire not only video data generated by the surveillance camera 110 but also video data stored in an external storage, a server, or the like that is not illustrated.

The storage unit 12 stores video data generated by the surveillance camera 110. The frame constituting the video data stored in the storage unit 12 is acquired by the tracking unit 17 and used for tracking of the tracked target.

The detection unit 13 acquires the verification frame from the storage unit 12. The detection unit 13 detects the tracked target from the acquired verification frame. The detection unit 13 allocates identifiers (IDs) to all the tracked targets detected from the verification frame. Hereinafter, it is assumed that the tracked target detected from the preceding frame is given a formal ID. The detection unit 13 gives a temporary ID to the tracked target detected from the subsequent frame.

For example, the detection unit 13 detects the tracked target from the verification frame by a detection technology such as a background subtraction method. For example, the detection unit 13 may detect the tracked target from the verification frame by a detection technology (for example, a detection algorithm) using a feature amount such as a motion vector. The tracked target detected by the detection unit 13 is a person or an object that is moving (also called a moving object). For example, when the tracked target is a person, the detection unit 13 detects the tracked target from the verification frame using a face detection technology. For example, the detection unit 13 may detect the tracked target from the verification frame using a human body detection technology or an object detection technology. For example, the detection unit 13 may detect an object that is not a moving object but has a feature amount such as a shape, a pattern, or a color that changes at a certain position.

The extraction unit 15 extracts a plurality of key points from the tracked target detected from the verification frame. For example, when the tracked target is a person, the extraction unit 15 extracts, as key points, the positions of the head, a joint, a limb, and the like of the person included in the verification frame. For example, the extraction unit 15 detects a skeleton structure of a person included in the verification frame, and extracts a key point based on the detected skeleton structure. For example, using a skeleton estimation technology using machine learning, the extraction unit 15 detects the skeleton structure of the person based on a feature such as a joint of the person included in the verification frame. For example, the extraction unit 15 detects the skeleton structure of the person included in the verification frame using the skeleton estimation technology disclosed in NPL 2 (NPL 2: Z. Cao et al., The IEEE Conference on Computer Vision and Pattern Recognition (CVPR), 2017, pp. 7291-7299).

For example, the extraction unit 15 gives numbers 1 to n to the extracted key points, such as 0 for the right shoulder and 1 for the right elbow (n is a natural number). For example, when the k-th key point of the person detected from the verification frame is not extracted, the key point is undetected (k is a natural number of equal to or more than 1 and equal to or less than n).

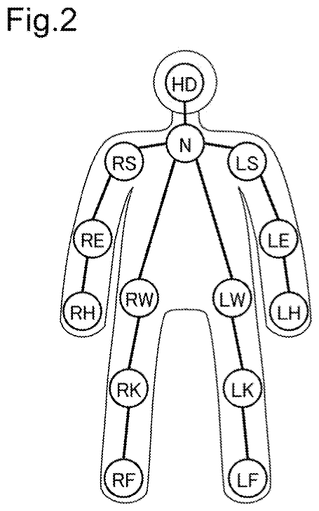

FIG. 2 is a conceptual diagram for explaining a key point in a case where the tracked target is a person. FIG. 2 is a front view of a person. In the example of FIG. 2, 14 key points are set for one person. HD is a key point set to the head. N is a key point set to the neck. RS and LS are key points set for the right shoulder and the left shoulder, respectively. RE and LE are key points set for the right elbow and the left elbow, respectively. RH and LH are key points set for the right hand and the left hand, respectively. RW and LW are key points set for the right waist and the left waist, respectively. RK and LK are key points set for the right knee and the left knee, respectively. RF and LF are key points set for the right foot and the left foot, respectively. The number of key points set for one person is not limited to 14. The positions of the key points are not limited to those of the example of FIG. 2. The key points may be set in the eyes, the eyebrows, the nose, the mouth, and the like in accordance with face detection using face detection in combination, for example.

The posture information generation unit 16 generates posture information of all tracked targets detected from the verification frame based on the key points extracted by the extraction unit 15. The posture information is position information of each key point of each tracked target in the verification frame. When the tracked target is tracked between two verification frames, posture information fₚ of the tracked target detected from the preceding frame is expressed by the following Expression 1, and posture information fₛ of the person detected from the subsequent frame is expressed by the following Expression 2.

fₚ={(xₚ₀, yₚ₀),(xₚ₁,yₚ₁), . . . , (xₚₙ,yₚₙ)}. . . (1)

fₛ={(xₛ₀,yₛ₀),(xₛ₁,yₛ₁), . . . , (xₛₙ,yₛₙ)}. . . (2)

In the above Expressions 1 and 2, (xₚₖ, yₚₖ) are the position coordinates of the k-th key point on the image (k and n are natural numbers). However, when the k-th key point of the person in the preceding frame is not extracted, the posture information fₚₖ is undetected. Similarly, when the k-th key point of the person in the subsequent frame is not extracted, the posture information fₛₖ is undetected.

The tracking unit 17 tracks the tracked target between frames by using the posture information generated for the tracked target detected from the preceding frame and the posture information generated for the tracked target detected from the preceding frame. The tracking unit 17 tracks the tracked target based on the position and the orientation of the posture information of the tracked target detected from each of at least two frames. The tracking unit 17 tracks the tracked target by allocating the ID of the tracked target detected from the preceding frame to the tracked target identified as the tracked target detected from the preceding frame among the tracked targets detected from the subsequent frame. When no tracked target corresponding to the tracked target detected from the subsequent frame is detected from the preceding frame, a temporary ID given to the tracked target detected from the subsequent frame is only required to be given as a formal ID, or a new ID as a formal ID.

For example, the tracking unit 17 calculates the position of the key point of the tracked target by using the coordinate information in the frame. The tracking unit 17 calculates the distance in a specific direction between the position of a reference key point and the head key point as the orientation of the tracked target. For example, the tracking unit 17 calculates the distance (distance in the x direction) from the neck key point to the head key point in the screen horizontal direction (x direction) as the orientation of the tracked target. The tracking unit 17 exhaustively calculates distances related to the position and the orientation for all the tracked targets detected from the preceding frame and all the tracked targets detected from the subsequent frame. The tracking unit 17 calculates, as a score, the sum of the distances regarding the position and the distances regarding the orientation calculated between all the tracked targets detected from the preceding frame and all the tracked targets detected from the subsequent frame. The tracking unit 17 tracks the tracked target by allocating the same ID to the tracked target having the minimum score among the pair of the tracked target detected from the preceding frame and the tracked target detected from the subsequent frame.

A distance Dₚ related to the position is a weighted mean of absolute values of differences in coordinate values of the key points extracted from the tracked targets being compared in the preceding frame and the subsequent frame. Assuming that the weight related to the position of each key point is wₖ, the tracking unit 17 calculates the distance Dₚ related to the position using the following Expression 3.

$${D}_{p} = \frac{{Σ}_{k = 0}^{n} [ ( \vert {x}_{p k} - {x}_{s k} \vert + \vert {y}_{p k} - {y}_{s k} \vert ) \times {w}_{k} ]}{{Σ}_{k = 0}^{n} {w}_{k}} \qquad ( 3 )$$

However, in Expression 3 described above, regarding the key point where the posture information fₚₖ or the posture information fₛₖ is undetected, the inside of the parentheses of the numerator and wₖ are set to 0.

A distance D_{d} related to the orientation is a weighted mean of absolute values of differences in the x coordinate relative to the reference point for the key points extracted from the tracked target being compared in the preceding frame and the subsequent frame. Assuming that the neck key point is a reference point, the reference point of the preceding frame is expressed as x_{p_neck}, the reference point of the subsequent frame is expressed as x_{s_neck}, and the weight related to the position of each key point is wₖ, the tracking unit 17 calculates the distance D_{d} related to the orientation using the following Expression 4.

$${D}_{d} = \frac{{Σ}_{k = 0}^{n} [ ( \vert ( {x}_{p k} - {x}_{{p}_{n e c k} )} - ( {x}_{s k} - {x}_{{s}_{n e c k}} ) \vert ) \times {w}_{k} ]}{{Σ}_{k = 0}^{n} {w}_{k}} \qquad ( 4 )$$

However, in Expression 4 described above, regarding the key point where the posture information fₚₖ or the posture information fₛₖ is undetected, the inside of the parentheses of the numerator and wₖ are set to 0.

The total value of the distance Dₚ related to the position and the distance D_{d} related to the orientation is a score S. The tracking unit 17 calculates the score S using the following Expression 5.

S=Dₚ+D_{d} . . . (5)

The tracking unit 17 exhaustively calculates the score S for the tracked target of a comparison target detected from the preceding frame and the subsequent frame. The tracking unit 17 gives the same ID to the tracked target having the minimum score S.

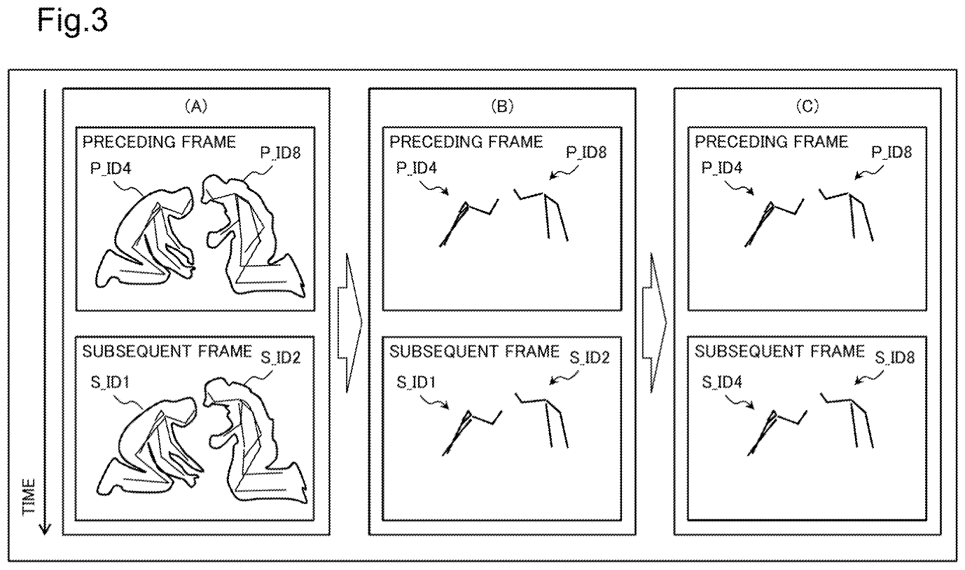

FIG. 3 is a conceptual diagram for explaining an example (A) of extraction of a key point, an example (B) of extraction of a key point (skeleton line) used for tracking, and an example (C) of ID allocation by the tracking unit 17. In FIG. 3, the upper figure is associated with the preceding frame, and the lower figure is associated with the subsequent frame.

(A) of FIG. 3 is an example in which key points are extracted from the tracked target included in the verification frame. (A) of FIG. 3 illustrates line segments connecting the contour of the tracked target and the key points extracted from the tracked target. (A) of FIG. 3 includes two persons in the preceding frame and the subsequent frame. One of the two persons extracted from the preceding frame is given an ID of P_ID4 and the other is given an ID of P_ID8. One of the two persons extracted from the subsequent frame is given an ID of S_ID1 and the other is given an ID of S_ID2. The ID given to each of the two persons extracted from the subsequent frame is temporary IDs.

(B) of FIG. 3 is a view in which only line segments (also called skeleton lines) connecting key points used for tracking of the tracked target are extracted from among the key points extracted from the tracked target. For example, the key points used for tracking may be set in advance or may be set for each verification.

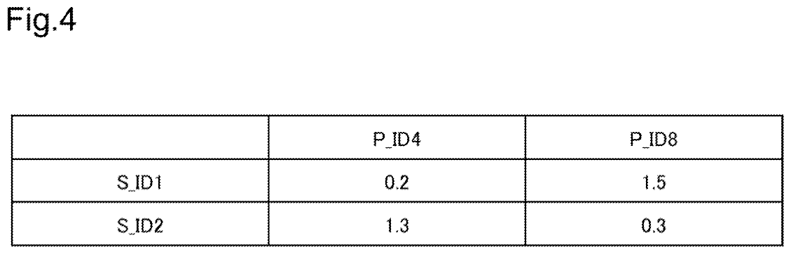

FIG. 4 is a table of the scores calculated by the tracking unit 17 regarding the example of FIG. 3. The score between the tracked target of S_ID1, detected from the subsequent frame, and P_ID4, detected from the preceding frame, is 0.2. The score between the tracked target of S_ID1, detected from the subsequent frame, and P_ID8, detected from the preceding frame, is 1.5. The score between the tracked target of S_ID2, detected from the subsequent frame, and P_ID4, detected from the preceding frame, is 1.3. The score between the tracked target of S_ID2, detected from the subsequent frame, and P_ID8, detected from the preceding frame, is 0.3. That is, the tracked target having the minimum score for the tracked target of S_ID1 is P_ID4. The tracked target having the minimum score for the tracked target of S_ID2 is P_ID8. The tracking unit 17 allocates the ID of P_ID4 to the tracked target of S_ID1 and the ID of P_ID8 to the tracked target of S_ID2.

(C) of FIG. 3 illustrates a situation in which the same ID is allocated to the same tracked target detected from the preceding frame and the subsequent frame based on the values of the scores of FIG. 4. In this way, the tracked target to which the same ID is allocated in the preceding frame and the subsequent frame is referred to in a further subsequent frame.

The tracking information output unit 18 outputs the tracking information including the tracking result by the tracking unit 17 to the terminal apparatus 120. For example, the tracking information output unit 18 outputs, as the tracking information, an image in which key points and skeleton lines are superimposed on the tracked target detected from the verification frame. For example, the tracking information output unit 18 outputs, as the tracking information, an image in which key points or skeleton lines are displayed at the position of the tracked target detected from the verification frame. For example, the image output from the tracking information output unit 18 is displayed on a display unit of the terminal apparatus 120.

The terminal apparatus 120 acquires, from the tracking apparatus 10 the tracking information for each of the plurality of frames constituting the video data. The terminal apparatus 120 causes the screen to display an image including the acquired tracking information. For example, the terminal apparatus 120 causes the screen to display an image including the tracking information in accordance with a display condition set in advance. For example, the display condition set in advance is a condition of displaying, in chronological order, images including tracking information corresponding to a predetermined number of consecutive frames including a frame number set in advance. For example, the display condition set in advance is a condition of displaying, in chronological order, images including tracking information corresponding to a plurality of frames generated in a predetermined time slot including a clock time set in advance. The display condition is not limited to the example presented here as long as it is set in advance.

### Operation

Next, an example of the operation of the tracking apparatus 10 will be described with reference to the drawings. Hereinafter, an outline of the processing by the tracking apparatus 10 and details of the tracking processing by the tracking unit 17 of the tracking apparatus 10 will be described.

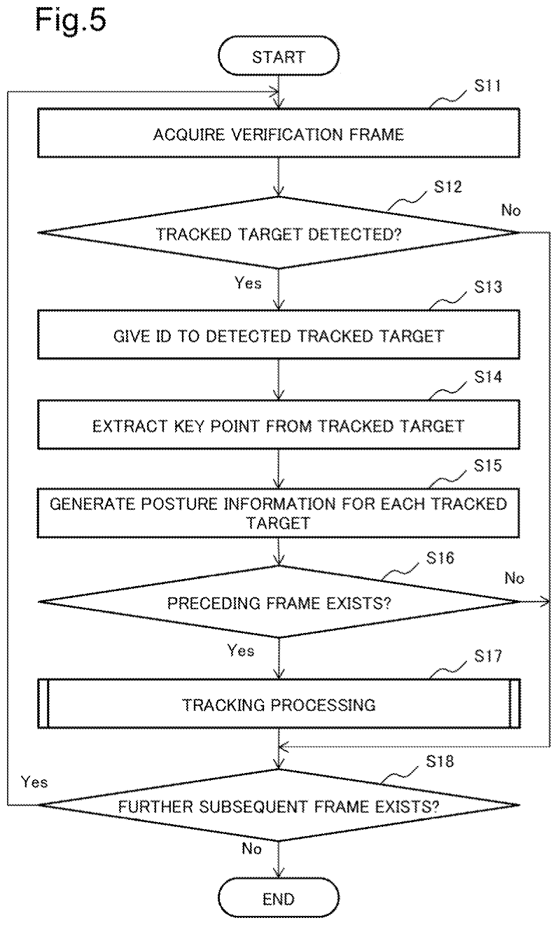

FIG. 5 is a flowchart for explaining the operation of the tracking apparatus 10. In FIG. 5, first, the tracking apparatus 10 acquires a verification frame (step S11). The tracking apparatus 10 may acquire a verification frame accumulated in advance or may acquire a verification frame input newly.

Upon detecting the tracked target from the verification frame (Yes in step S12), the tracking apparatus 10 gives an ID to the detected tracked target (step S13). At this time, the ID given to the tracked target by the tracking apparatus 10 is a temporary ID. On the other hand, if the tracked target is not detected from the verification frame (No in step S12), the process proceeds to step S18.

Next to step S13, the tracking apparatus 10 extracts key points from the detected tracked target (step S14). If a plurality of tracked targets are detected, the tracking apparatus 10 extracts key points for each detected tracked target.

Next, the tracking apparatus 10 generates posture information for each tracked target (step S15). The posture information is information in which the position information of the key points extracted for each tracked target is integrated for each tracked target. If a plurality of tracked targets are detected, the tracking apparatus 10 generates posture information for each detected tracked target.

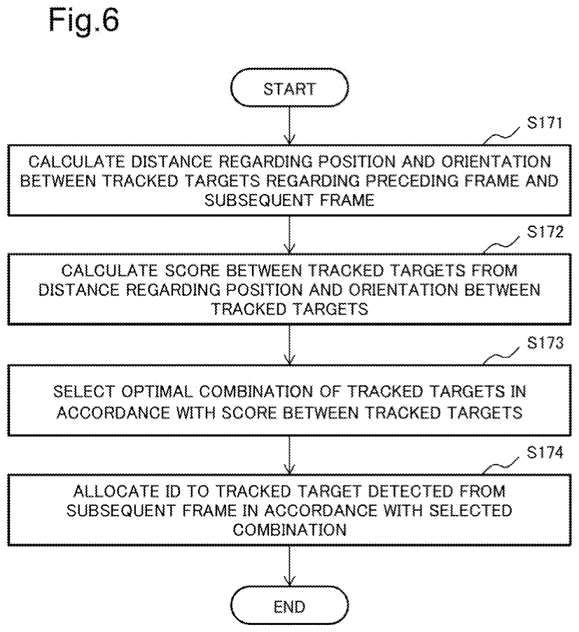

Here, if a preceding frame exists (Yes in step S16), the tracking apparatus 10 executes the tracking processing (step S17). On the other hand, if a preceding frame does not exist (No in step S16), the process proceeds to step S18. Details of the tracking processing will be described later with reference to the flowchart of FIG. 6.

Then, if further subsequent frame exists (Yes in step S18), the process returns to step S11. On the other hand, if further subsequent frame does not exist (No in step S18), the process according to the flowchart of FIG. 5 ends.

FIG. 6 is a flowchart for explaining tracking processing by the tracking unit 17 of the tracking apparatus 10. In FIG. 6, first, the tracking unit 17 calculates the distance regarding the position and the orientation between tracked targets regarding the preceding frame and the subsequent frame (step S171).

Next, the tracking unit 17 calculates a score between the tracked targets from the distance regarding the position and the orientation between the tracked targets (step S172). For example, the tracking unit 17 calculates, as the score, the sum of the distance regarding the position and the distance regarding the orientation between the tracked targets.

Next, the tracking unit 17 selects an optimal combination of tracked targets in accordance with the score between the tracked targets (step S173). For example, the tracking unit 17 selects a combination of the tracked targets having the minimum score from the preceding frame and the subsequent frame.

Next, the tracking unit 17 allocates an ID to the tracked target detected from the subsequent frame in accordance with the selected combination (step S174). For example, the tracking unit 17 allocates the same ID to the combination of the tracked targets having the minimum score in the preceding frame and the subsequent frame.

As described above, the tracking apparatus of the tracking system of the present example embodiment includes the detection unit, the extraction unit, the posture information generation unit, and the tracking unit. The detection unit detects the tracked target from at least two frames constituting the video data. The extraction unit extracts at least one key point from the detected tracked target. The posture information generation unit generates posture information of the tracked target based on the at least one key point. The tracking unit tracks the tracked target based on the position and the orientation of the posture information of the tracked target detected from each of the at least two frames.

The tracking apparatus of the present example embodiment tracks the tracked target based on the position and the orientation of the posture information of the tracked target. When the tracked target is tracked only by the position, there is a possibility that identification numbers are switched between different tracked targets when a plurality of tracked targets pass by one another. The tracking apparatus of the present example embodiment tracks the tracked target based on not only the position of the tracked target but also the orientation of the tracked target, and therefore, there is a low possibility that identification numbers are switched between different tracked targets when a plurality of tracked targets pass by one another. Therefore, according to the tracking apparatus of the present example embodiment, it is possible to track a plurality of tracked targets over a plurality of frames based on the posture of the tracked target. That is, according to the tracking apparatus of the present example embodiment, it is possible to track a plurality of tracked targets based on postures in a plurality of frames constituting a video.

According to the tracking apparatus of the present example embodiment, the tracked target can be tracked based on the posture even if a reference image for each posture of each tracked target is not stored in a database. Furthermore, according to the tracking apparatus of the present example embodiment, the tracking accuracy is not deteriorated even when conditions such as the congestion degree, the angle of view, the distance between the camera and the tracked target, and the frame rate are different from the learned conditions. That is, according to the present example embodiment, it is possible to highly accurately track the tracked target in frames constituting the video. The tracking apparatus of the present example embodiment can be applied to, for example, surveillance of the flow line of persons in the town, public facilities, stores, and the like.

In one aspect of the present example embodiment, the tracking unit calculates, based on the posture information, a score in accordance with the distance regarding the position and the orientation related to the tracked target detected from each of at least two frames. The tracking unit tracks the tracked target based on the calculated score. According to the present aspect, by tracking the tracked target based on the score in accordance with the distance regarding the position and the orientation of the tracked target, it is possible to continuously track a plurality of tracked targets between frames constituting the video.

In one aspect of the present example embodiment, regarding the tracked target detected from each of at least two frames, the tracking unit tracks, as the same tracked target, a pair having the minimum score. According to the present aspect, by identifying the pair having the minimum score as the same tracked target, it is possible to more continuously track the tracked target between frames constituting the video.

In one aspect of the present example embodiment, regarding the tracked target detected from each of at least two frames, the tracking unit calculates a weighted mean of absolute values of differences between coordinate values of the key points as the distance regarding the position. Regarding the tracked target detected from each of the at least two frames, the tracking unit calculates a weighted mean of absolute values of a difference between relative coordinate values in a specific direction with respect to a reference point of the key point as the distance regarding the orientation. The tracking unit calculates, as a score, a sum of distance regarding the position and the distance regarding the orientation for the tracked target detected from each of the at least two frames. According to the present aspect, weights related to the position and the orientation are clearly defined, and tracking of the tracked target between frames can be appropriately performed in accordance with the weights.

In one aspect of the present example embodiment, the tracking apparatus includes the tracking information output unit that outputs tracking information related to tracking of the tracked target. The tracking information is an image in which a key point is displayed at the position of the tracked target detected from the verification frame, for example. According to the present aspect, by causing the screen of the display equipment to display the image in which the tracking information is superimposed on the tracked target, it becomes easy to visually grasp the posture of the tracked target.

### Second Example Embodiment

Next, the tracking system according to the second example embodiment will be described with reference to the drawings. The tracking system of the present example embodiment is different from that of the first example embodiment in that the distance regarding the position and the orientation between tracked targets is normalized by the size of the tracked target in a frame.

### Configuration

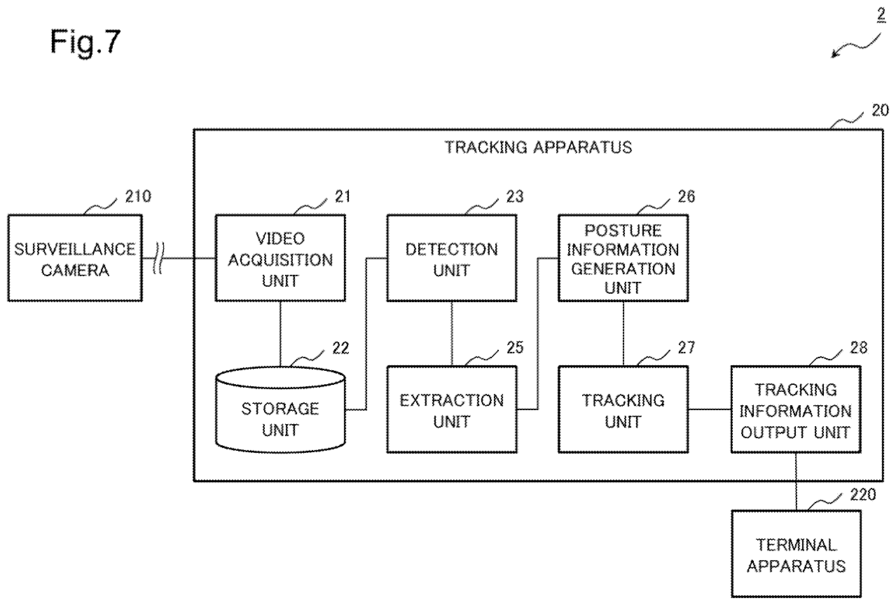

FIG. 7 is a block diagram illustrating an example of the configuration of a tracking system 2 of the present example embodiment.

The tracking system 2 includes a tracking apparatus 20, a surveillance camera 210, and a terminal apparatus 220. Although only one surveillance camera 210 and one terminal apparatus 220 are illustrated in FIG. 7, a plurality of surveillance cameras 210 and a plurality of terminal apparatuses 220 may be provided. Since the surveillance camera 210 and the terminal apparatus 220 are similar to the surveillance camera 110 and the terminal apparatus 120, respectively, of the first example embodiment, detailed description will be omitted.

The tracking apparatus 20 includes a video acquisition unit 21, a storage unit 22, a detection unit 23, an extraction unit 25, a posture information generation unit 26, a tracking unit 27, and a tracking information output unit 28. For example, the tracking apparatus 20 is disposed on a server or a cloud. For example, the tracking apparatus 20 may be provided as an application installed in the terminal apparatus 220. Each of the video acquisition unit 21, the storage unit 22, the detection unit 23, the extraction unit 25, the posture information generation unit 26, and the tracking information output unit 28 is similar to the corresponding configuration of the first example embodiment, and therefore, detailed description will be omitted.

The tracking unit 27 tracks the tracked target between frames by using the posture information generated for the tracked target detected from the preceding frame and the posture information generated for the tracked target detected from the preceding frame. The tracking unit 27 tracks the tracked target based on the position and the orientation of the posture information of the tracked target detected from each of at least two frames. The tracking unit 27 tracks the tracked target by allocating the ID of the tracked target detected from the preceding frame to the tracked target identified as the tracked target detected from the preceding frame among the tracked targets detected from the subsequent frame. When no tracked target corresponding to the tracked target detected from the subsequent frame is detected from the preceding frame, a temporary ID given to the tracked target detected from the subsequent frame is only required to be given as a formal ID, or a new ID as a formal ID.

For example, the tracking unit 27 exhaustively calculates distances related to the position and the orientation normalized by the size of the tracked target for all the tracked targets detected from the preceding frame and all the tracked targets detected from the subsequent frame. The tracking unit 27 calculates, as a normalized score, the sum of distances related to the position and the orientation normalized by the size of the tracked targets, calculated for all the tracked targets detected from the preceding frame and all the tracked targets detected from the subsequent frame. The tracking unit 27 tracks the tracked target by allocating the same ID to the tracked target having the minimum normalized score among the pair of the tracked target detected from the preceding frame and the tracked target detected from the subsequent frame. For example, when the person of the tracked target in the frame is walking upright, it is possible to estimate the size by surrounding the person with a frame such as a rectangle. However, when the person of the tracked target in the frame is sitting or frequently changing the direction, it is difficult to estimate the size only by surrounding the person with a rectangular frame or the like. In such a case, the size is only required to be estimated based on the skeleton of the person of the tracked target as follows.

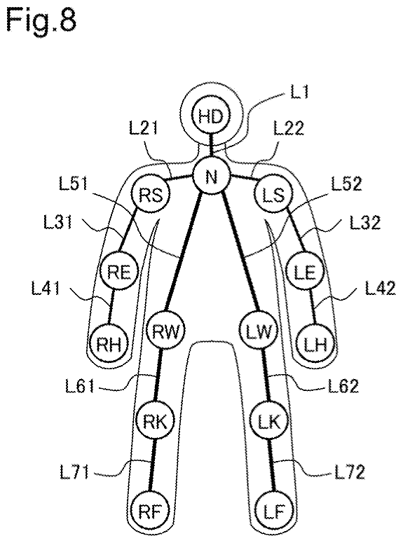

FIG. 8 is a conceptual diagram for explaining a skeleton line used when the tracking unit 27 estimates the size of the tracked target (person). The skeleton line is a line segment connecting specific key points. FIG. 8 is a front view of a person. In the example of FIG. 8, 14 key points are set for one person, and 15 skeleton lines are set. L1 is a line segment connecting HD and N. L21 is a line segment connecting N and RS, and L22 is a line segment connecting N and LS. L31 is a line segment connecting RS and RE, and L32 is a line segment connecting LS and LE. L41 is a line segment connecting RE and RH, and L42 is a line segment connecting LE and LH. L51 is a line segment connecting N and RW, and L52 is a line segment connecting N and LW. L61 is a line segment connecting RW and RK, and L62 is a line segment connecting LW and LK. L71 is a line segment connecting RK and RF, and L42 is a line segment connecting LK and LF. The number of key points set for one person is not limited to 14. The number of skeleton lines set for one person is not limited to 13. The positions of the key points and the skeleton lines are not limited to those of the example of FIG. 8.

The tracking unit 27 calculates a height (called a number of height pixels) when the person stands upright based on the skeleton line related to the person in the verification frame. The number of height pixels is associated with the height of the person in the verification frame (entire body length of the person in two frames). The tracking unit 27 obtains the number of height pixels (the number of pixels) from the length of each skeleton line in the frame.

For example, the tracking unit 27 estimates the number of height pixels by using the length of the skeleton line from the head (HD) to the foot (RF, LF). For example, the tracking unit 27 calculates, as the number of height pixels, a sum H_{R} of the lengths L1, L51, L61, and L71 in the verification frame among the skeleton lines extracted from the person in the verification frame. For example, the tracking unit 27 calculates, as the number of height pixels, a sum H_{L} of the lengths L1, L52, L62, and L72 in the verification frame among the skeleton lines extracted from the person in the verification frame. For example, the tracking unit 27 calculates, as the number of height pixels, the mean value of the sum H_{R} of the lengths of L1, L51, L61, and L71 in the verification frame and the sum H_{L} of the lengths of L1, L52, L62, and L72 in the verification frame. For example, in order to calculate the number of height pixels more accurately, the tracking unit 27 may calculate the number of height pixels after correcting each skeleton line with a correction coefficient for correcting the inclination, posture, and the like of each skeleton line.

For example, the tracking unit 27 may estimate the number of height pixels using the lengths of individual skeleton lines based on the relationship between the length of each skeleton line and the height of an average person. For example, the length of the skeleton line (L1) connecting the head (HD) and the neck (N) is about 20% of the height. For example, the length of the skeleton line connecting the elbow (RE, LE) and the hand (RH, LH) is about 25% of the height. As described above, when the ratio of the length of each skeleton line to the height is stored in a storage unit (not illustrated), the number of height pixels corresponding to the height of the person can be estimated based on the length of each skeleton line of the person detected from the verification frame. The ratio of the length of each skeleton line of the average person to the height tends to vary depending on the age. Therefore, the ratio of the length of each skeleton line of the average person to the height may be stored in the storage unit for each age of the person. For example, if the ratio of the length of each skeleton line of the average person to the height is stored in the storage unit, when an upright person can be detected from the verification frame, the age of the person can roughly be estimated based on the length of each skeleton line of the person. The estimation method of the number of height pixels based on the length of the skeleton line described above is an example, and does not limit the estimation method of the number of height pixels by the tracking unit 27.

The tracking unit 27 normalizes the distance Dₚ related to the position and the distance D_{d} related to the orientation with the estimated number of height pixels. Here, regarding the person of a comparison target, let the height detected from the preceding frame be Hₚ, and let the height detected from the subsequent frame be Hs. The tracking unit 27 calculates a normalized distance NDₚ related to the position using the following Expression 6, and calculates a normalized distance ND_{d} related to the orientation using the following Expression 7.

$$N {D}_{p} = \frac{{\sum }_{k = 0}^{n} [ ( \vert {x}_{p k} - {x}_{s k} \vert + \vert {y}_{p k} - {y}_{s k} \vert ) \times {w}_{k} ]}{{\sum }_{k = 0}^{n} {w}_{k}} \div \frac{{H}_{p} + {H}_{s}}{2} \qquad ( 6 )$$

$$N {D}_{d} = \frac{{\sum }_{k = 0}^{n} [ ( \vert ( {x}_{p k} - {x}_{p \_ neck} ) - ( {x}_{s k} - {x}_{{s}_{n e c k}} ) \vert ) \times {w}_{k} ]}{{\sum }_{k = 0}^{n} {w}_{k}} \div \frac{{H}_{p} + {H}_{s}}{2} \qquad ( 7 )$$

Then, the tracking unit 27 calculates a normalized score (normalized score NS) using the following Expression 8.

NS=NDₚ+ND_{d} . . . (8)

The tracking unit 27 exhaustively calculates the normalized score NS for the tracked target under comparison detected from the preceding frame and the subsequent frame, and gives the same ID to the tracked target whose normalized score NS is the minimum.

### Operation

Next, an example of the operation of the tracking apparatus 20 will be described with reference to the drawings. Since the outline of the processing by the tracking apparatus 20 is similar to that of the first example embodiment, it is omitted. Hereinafter, details of the tracking processing by the tracking unit 27 of the tracking apparatus 20 will be described.

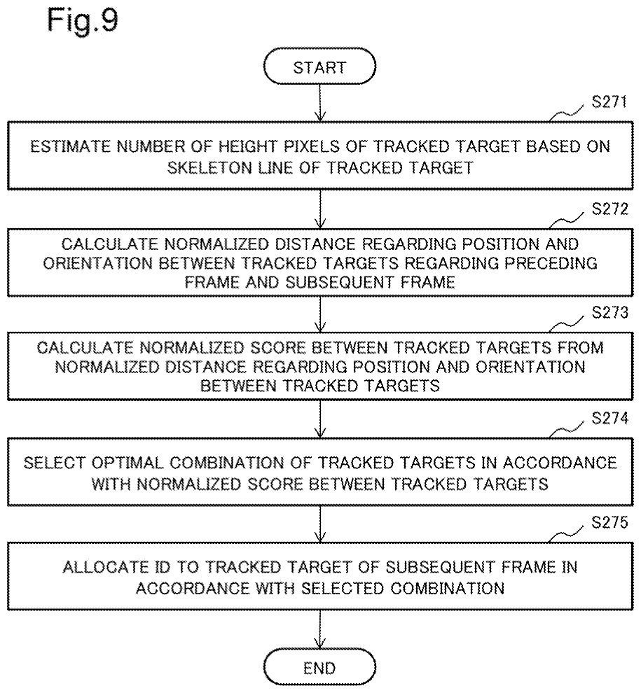

FIG. 9 is a flowchart for explaining tracking processing by the tracking unit 27 of the tracking apparatus 20. In FIG. 9, first, the tracking unit 27 estimates the number of height pixels of the tracked target based on the skeleton line of the detection target detected from the verification frame (step S271).

Next, the tracking unit 27 calculates a normalized distance regarding the position and the orientation between the tracked targets regarding the preceding frame and the subsequent frame (step S272). The normalized distance is a distance regarding the position and the orientation normalized with the estimated number of height pixels.

Next, the tracking unit 27 calculates a normalized score between the tracked targets from the normalized distance regarding the position and the orientation between the tracked targets (step S273). For example, the tracking unit 17 calculates, as the normalized score, the sum of the normalized distance regarding the position between the tracked targets and the normalized distance regarding the orientation.

Next, the tracking unit 27 selects an optimal combination of tracked targets in accordance with the normalized score between the tracked targets (step S274). For example, the tracking unit 27 selects a combination of the tracked targets having the minimum normalized score from the preceding frame and the subsequent frame.

Next, the tracking unit 27 allocates an ID to the tracked target detected from the subsequent frame in accordance with the selected combination (step S275). For example, the tracking unit 27 allocates the same ID to the combination of the tracked targets having the minimum normalization score in the preceding frame and the subsequent frame.

As described above, the tracking apparatus of the tracking system of the present example embodiment includes the detection unit, the extraction unit, the posture information generation unit, and the tracking unit. The detection unit detects the tracked target from at least two frames constituting the video data. The extraction unit extracts at least one key point from the detected tracked target. The posture information generation unit generates posture information of the tracked target based on the at least one key point. The tracking unit tracks the tracked target based on the position and the orientation of the posture information of the tracked target detected from each of the at least two frames.

Furthermore, in the present example embodiment, the tracking unit estimates the number of height pixels of the tracked target based on a skeleton line connecting any of the plurality of key points. The tracking unit normalizes the score with the estimated number of height pixels, and tracks the tracked target detected from each of the at least two frames in accordance with the normalized score.

In the present example embodiment, the score is normalized in accordance with the size of the tracked target in the frame. Therefore, according to the present example embodiment, the tracked target appearing large due to the positional relationship with the surveillance camera is no longer overestimated, and tracking bias at the position in the frame can be reduced. Therefore, according to the present example embodiment, tracking can be performed with higher accuracy over a plurality of frames constituting a video. According to the present example embodiment, since tracking can be performed regardless of the posture of the tracked target, the tracking of the tracked target can be continued even when the change in posture between frames is large.

In one aspect of the present example embodiment, the tracking apparatus includes the tracking information output unit that outputs tracking information related to tracking of the tracked target. The tracking information is, for example, an image in which a skeleton line is displayed at the position of the tracked target detected from the verification frame. According to the present aspect, by causing the screen of the display equipment to display the image in which the tracking information is superimposed on the tracked target, it becomes easy to visually grasp the posture of the tracked target.

### Third Example Embodiment

Next, the tracking system according to the third example embodiment will be described with reference to the drawings. The tracking system of the present example embodiment is different from those of the first and second example embodiments in that a user interface for setting weights of a position and an orientation and setting a key point is displayed.

### Configuration

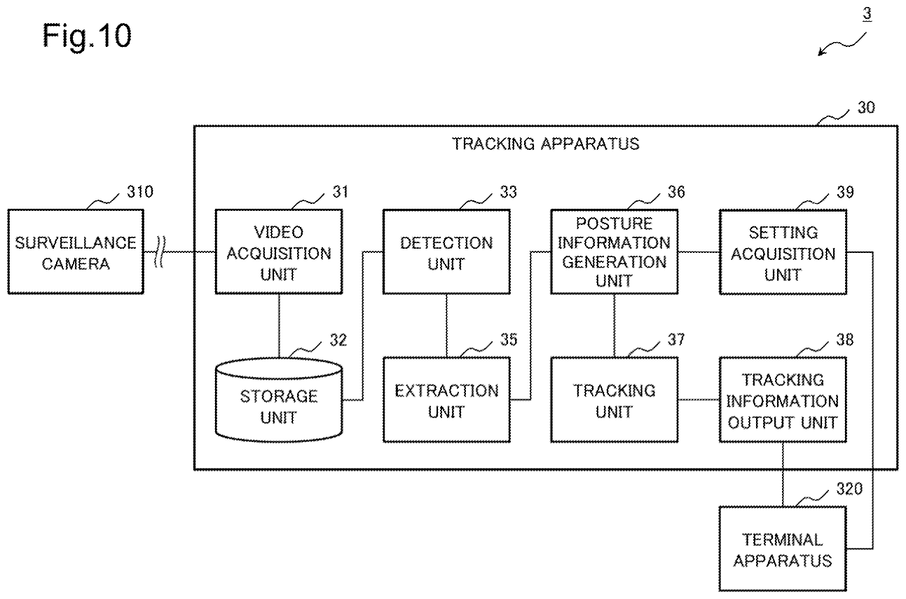

FIG. 10 is a block diagram illustrating an example of the configuration of a tracking system 3 of the present example embodiment. The tracking system 3 includes a tracking apparatus 30, a surveillance camera 310, and a terminal apparatus 320. Although only one surveillance camera 310 and one terminal apparatus 320 are illustrated in FIG. 10, a plurality of surveillance cameras 310 and a plurality of terminal apparatuses 320 may be provided. Since the surveillance camera 310 is similar to the surveillance camera 110 of the first example embodiment, detailed description will be omitted.

The tracking apparatus 30 includes a video acquisition unit 31, a storage unit 32, a detection unit 33, an extraction unit 35, a posture information generation unit 36, a tracking unit 37, a tracking information output unit 38, and a setting acquisition unit 39. For example, the tracking apparatus 30 is disposed on a server or a cloud. For example, the tracking apparatus 30 may be provided as an application installed in the terminal apparatus 320. Each of the video acquisition unit 31, the storage unit 32, the detection unit 33, the extraction unit 35, the posture information generation unit 36, the tracking unit 37, and the tracking information output unit 38 is similar to the corresponding configuration of the first example embodiment, and therefore, detailed description will be omitted.

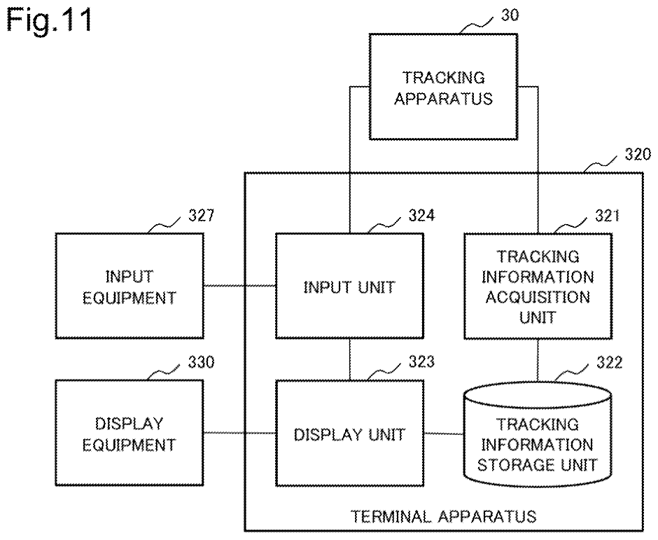

FIG. 11 is a block diagram illustrating an example of the configuration of the terminal apparatus 320 and the like. The terminal apparatus 320 includes a tracking information acquisition unit 321, a tracking information storage unit 322, a display unit 323, and an input unit 324. FIG. 11 also illustrates the tracking apparatus 10, input equipment 327, and display equipment 330 connected to the terminal apparatus 320.

The tracking information acquisition unit 321 acquires, from the tracking apparatus 30, the tracking information for each of the plurality of frames constituting the video data. The tracking information acquisition unit 321 stores the tracking information for each frame in the tracking information storage unit 322.

The tracking information storage unit 322 stores the tracking information acquired from the tracking apparatus 30. The tracking information stored in the tracking information storage unit 322 is displayed as a graphical user interface (GUI) on the screen of the display unit 323 in response to, for example, a user operation or the like.

The display unit 323 is connected to the display equipment 330 having a screen. The display unit 323 acquires the tracking information from the tracking information storage unit 322. The display unit 323 causes the screen of the display equipment 330 to display the display information including the acquired tracking information. The terminal apparatus 320 may include the function of the display equipment 330.

For example, the display unit 323 receives a user operation via the input unit 324, and causes the screen of the display equipment 330 to display the display information in response to the received operation content. For example, the display unit 323 causes the screen of the display equipment 330 to display the display information corresponding to the frame with the frame number designated by the user. For example, the display unit 323 causes the screen of the display equipment 330 to display, in chronological order, display information corresponding to each of a plurality of series of frames including the frame with the frame number designated by the user.

For example, the display unit 323 may cause the screen of the display equipment 330 to display at least one piece of display information in accordance with a display condition set in advance. For example, the display condition set in advance is a condition of displaying, in chronological order, a plurality of pieces of display information corresponding to a predetermined number of consecutive frames including a frame number set in advance. For example, the display condition set in advance is a condition of displaying, in chronological order, a plurality of pieces of display information corresponding to a plurality of frames generated in a predetermined time slot including a clock time set in advance. The display condition is not limited to the example presented here as long as it is set in advance.

The input unit 324 is connected to the input equipment 327 that receives a user operation. For example, the input equipment 327 is achieved by a keyboard, a touchscreen, a mouse, or the like. The input unit 324 outputs, to the tracking apparatus 30, the operation content by the user input via the input equipment 327. When receiving designation of video data, a frame, display information, and the like from the user, the input unit 324 outputs, to the display unit 323, an instruction to cause the screen to display the designated image.

The setting acquisition unit 39 acquires a setting input using the terminal apparatus 320 The setting acquisition unit 39 acquires setting of weights related to the position and the orientation, setting of key points, and the like. The setting acquisition unit 39 reflects the acquired setting in the function of the tracking apparatus 30.

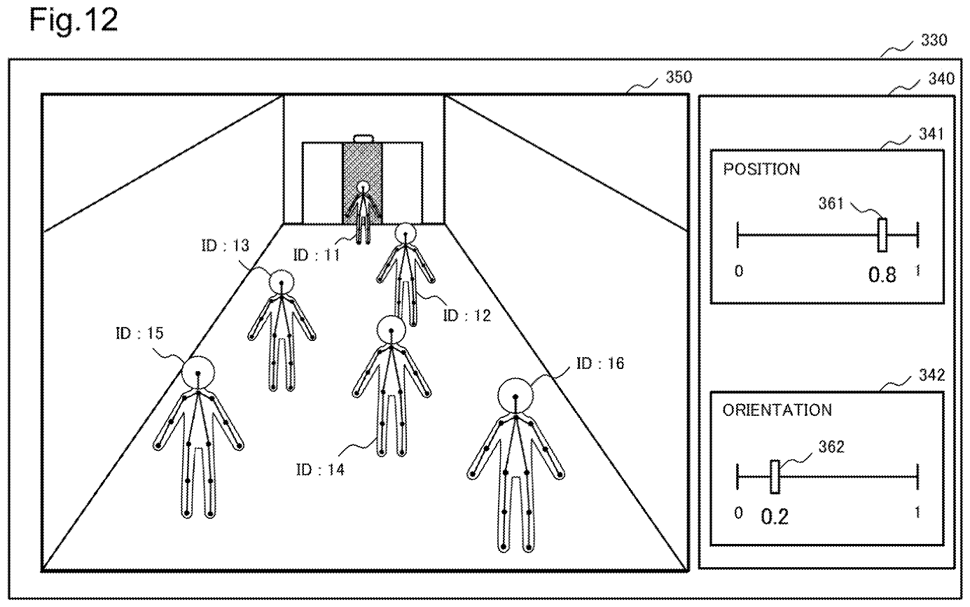

FIG. 12 is a conceptual diagram for explaining an example of display information displayed on the screen of the display equipment 330. A weight setting region 340 and an image display region 350 are set on the screen of the display equipment 330. In the setting region 340, a first operation image 341 for setting a weight related to the position and a second operation image 342 for setting a weight related to the orientation are displayed. In the image display region 350, a tracking image for each frame constituting the video captured by the surveillance camera 310 is displayed. A display region other than the weight setting region 340 and the image display region 350 may be set on the screen of the display equipment 330. The display positions of the weight setting region 340 and the image display region 350 on the screen can be discretionarily changed.

In the first operation image 341, a scrollbar for setting a weight related to the position is displayed. The weight related to the position is an index value indicating how much the positions of the tracked targets are emphasized when comparing the tracked targets detected from each of the preceding frame and the subsequent frame. The weight related to the position is set in a range of equal to or more than 0 and equal to or less than 1. A minimum value (left end) and a maximum value (right end) of the weight related to the position are set in the scrollbar displayed in the first operation image 341. When a knob 361 on the scrollbar is moved left and right, the weight related to the position is changed. In the example of FIG. 12, the weight related to the position is set to 0.8. In the first operation image 341, a vertical scrollbar may be displayed instead of a horizontal scrollbar. The first operation image 341 may be caused to display not the scrollbar but a spin button, a combo box, and the like for setting the weight related to the position. An element different from the scrollbar or the like may be displayed in the first operation image 341 in order to set the weight related to the position.

In the second operation image 342, a scrollbar for setting a weight related to the orientation is displayed. The weight related to the orientation is an index value indicating how much the orientation of the tracked targets are emphasized when comparing the tracked targets detected from each of the preceding frame and the subsequent frame. The weight related to the orientation is set in a range of equal to or more than 0 and equal to or less than 1. A minimum value (left end) and a maximum value (right end) of the weight related to the orientation are set in the scrollbar displayed in the second operation image 342. When a knob 362 on the scrollbar is moved left and right, the weight related to the orientation is changed. In the example of FIG. 12, the weight related to the orientation is set to 0.2. In the second operation image 342, a vertical scrollbar may be displayed instead of a horizontal scrollbar. The second operation image 342 may be caused to display not the scrollbar but a spin button, a combo box, and the like for setting the weight related to the orientation. An element different from the scrollbar or the like may be displayed in the second operation image 342 in order to set the weight related to the orientation.

In the example of FIG. 12, a frame including, as tracked targets, six persons given IDs of 11 to 16 is displayed in the image display region 350. FIG. 12 illustrates an example in which the image display region 350 is caused to display an image corresponding to a subsequent frame. The image display region 350 may be caused to display a preceding frame and a subsequent frame side by side. The image display region 350 may be caused to display a preceding frame and a subsequent frame so as to be switched in response to selection of a button not illustrated or the like.

In the example of FIG. 12, the tracking information associated with the person detected from the frame is displayed. In the tracking information, a plurality of key points extracted from the person detected from the frame and a line segment (skeleton line) connecting those key points are displayed in association with the person. For example, it may be possible to switch whether to display the tracking information in the image display region 350 in response to the user operation via the terminal apparatus 320. In the example of FIG. 12, the six persons walk in the same orientation. As described above, in a case where there are many tracked targets moving in the same orientation, it is preferable to emphasize the position as compared with the orientation in order to track the tracked target with high accuracy between frames. In the case where there are many tracked targets moving in the same orientation, if the weight related to the position and the weight related to the orientation are the same, there is a possibility that the weight related to the orientation is excessively estimated, and the tracking accuracy is deteriorated. Therefore, in the case where there are many tracked targets moving in the same orientation, if the weight related to the position is set to be large, the weight related to the orientation is set to be small, whereby the deterioration in the tracking accuracy can be reduced.

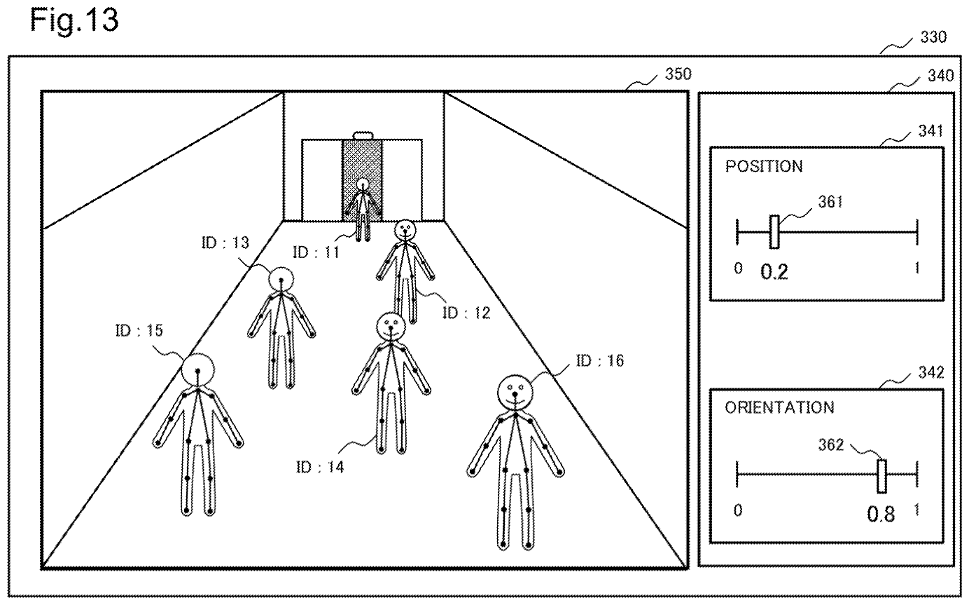

FIG. 13 is a conceptual diagram for explaining another example of the display information displayed on the screen of the display equipment 330. In the example of FIG. 13, the weight related to the position is set to 0.2, and the weight related to the orientation is set to 0.8. In the example of FIG. 13, six persons walk so as to pass one another. In this manner, in the case where there are many tracked targets moving so as to pass one another, it is preferable to emphasize the orientation as compared with the position in order to track the tracked target with high accuracy between frames. In the case where there are many tracked targets moving in a passing manner, if the weight related to the orientation and the weight related to the position are the same, there is a possibility that the weight related to the position is excessively estimated, and the tracking accuracy is deteriorated. Therefore, in the case where there are many tracked targets moving in a passing manner, the weight related to the orientation is set to be large, and the weight related to the position is set to be small, whereby the deterioration in the tracking accuracy can be reduced.

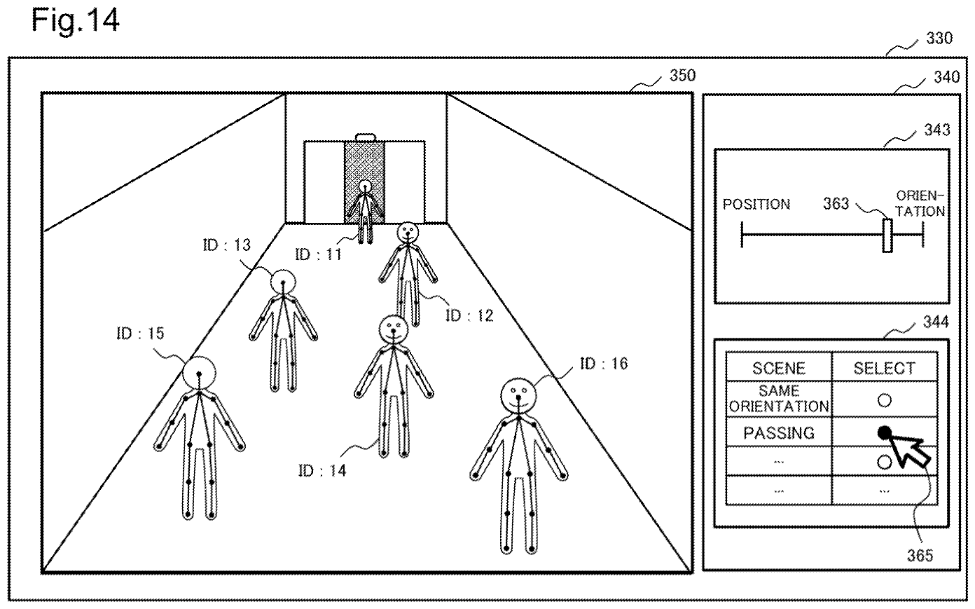

FIG. 14 is a conceptual diagram for explaining still another example of the display information displayed on the screen of the display equipment 330. In the example of FIG. 14, a third operation image 343 for setting weights related to the position and the orientation and a fourth operation image 344 for setting weights related to the position and the orientation according to the scene are displayed in the weight setting region 340. The third operation image 343 and the fourth operation image 344 need not be simultaneously displayed in the weight setting region 340.

In the third operation image 343, a scrollbar for setting weights related to the position and is displayed. A maximum value (left end) of the weight related to the position and a maximum value (right end) of the weight related to the orientation are set in the scrollbar displayed on the first operation image 341. When the weight related to the position is set to the maximum value (left end), the weight related to the orientation is set to the minimum value. On the other hand, when the weight related to the orientation is set to the maximum value (right end), the weight related to the position is set to the minimum value. When a knob 363 on the scrollbar is moved left and right, the weights related to the position and the orientation are collectively changed. In the third operation image 343, a vertical scrollbar may be displayed instead of a horizontal scrollbar. The third operation image 343 may be caused to display not the scrollbar but a spin button, a combo box, and the like for setting the weight related to the position and the orientation. An element different from the scrollbar or the like may be displayed in the third operation image 343 in order to set the weights related to the position and the orientation. The weight related to the position and the weight related to the orientation are often in a complementary relationship according to the scene. Therefore, in a scene where importance is placed on the weight related to the position, it is preferable to reduce the weight related to the orientation. In contrast, in a scene where importance is placed on the weight related to the orientation, it is preferable to reduce the weight related to the position. In the example of FIG. 14, since the weights related to the position and can be collectively set according to the situation of the tracked target in the frame displayed in the image display region 350, the setting of the weights related to the position and the orientation can be appropriately changed according to the scene.

In the fourth operation image 344, a check box for setting a weight related to the position and the orientation according to the scene is displayed. FIG. 14 illustrates an example in which a weight according to the scene of “passing” is set in response to the operation of a pointer 365 via the terminal apparatus 320. In the example of FIG. 14, when any scene is selected in the fourth operation image 344, the setting of the third operation image 343 is also changed at the same time. For example, in a scene where many persons pass by one another, it is preferable to place importance on the orientation in consideration of the orientation of the face so that an ID is less likely to be crossed among the tracked targets that pass by one another. For example, when the scene of “passing” is selected, the weight of the position is set to 0.2, and the weight of the orientation is set to 0.8. For example, in a scene where many persons move in the same orientation, the position is only required to be emphasized regardless of the face orientation. For example, when a scene of “same orientation” is selected, the weight of the position is set to and the weight of the orientation is set to 0.2. By selecting the scene according to the situation of the tracked target in the frame displayed in the image display region 350, setting of the weights related to the position and the orientation can be intuitively changed.

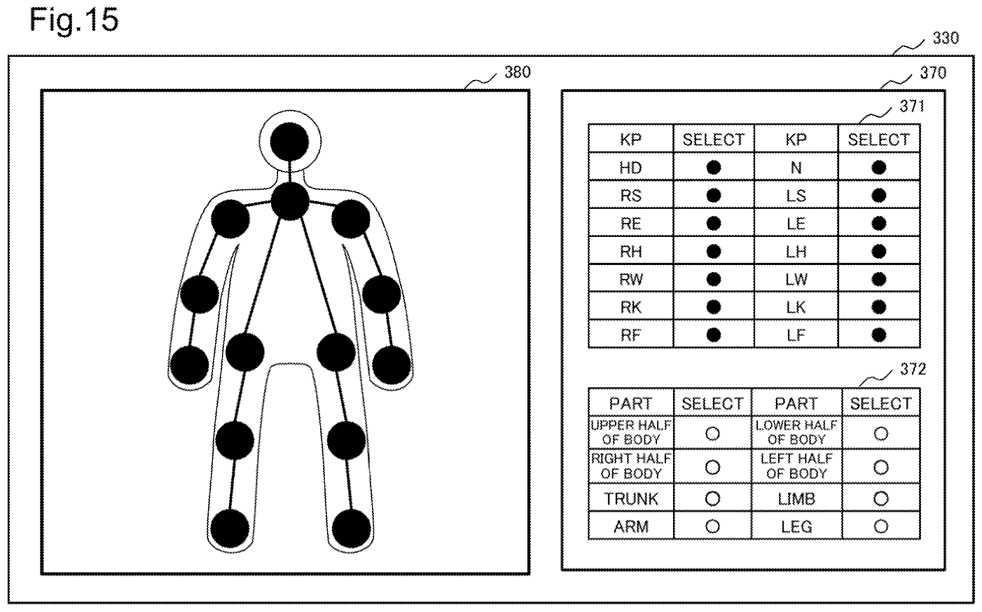

FIG. 15 is a conceptual diagram for explaining another example of the display information displayed on the screen of the display equipment 330. A key point designation region 370 and a key point designation region 380 are set on the screen of the display equipment 330. An individual designation image 371 and a collective designation image 372 are displayed in the key point designation region 370. An image in which the key point designated in the key point designation region 370 is associated with the human body is displayed in the key point designation region 380. For example, the key point is designated in accordance with the selection of each key point in the individual designation image 371 or the selection of the body part in the collective designation image 372. In the example of FIG. 15, all the key points designated in the individual designation image 371 are displayed in the key point designation region 380. The selected key points are displayed in black in the key point designation region 380. A display region other than the key point designation region 370 and the key point designation region 380 may be set on the screen of the display equipment 330. The display positions of the key point designation region 370 and the key point designation region 380 on the screen can be discretionarily changed.

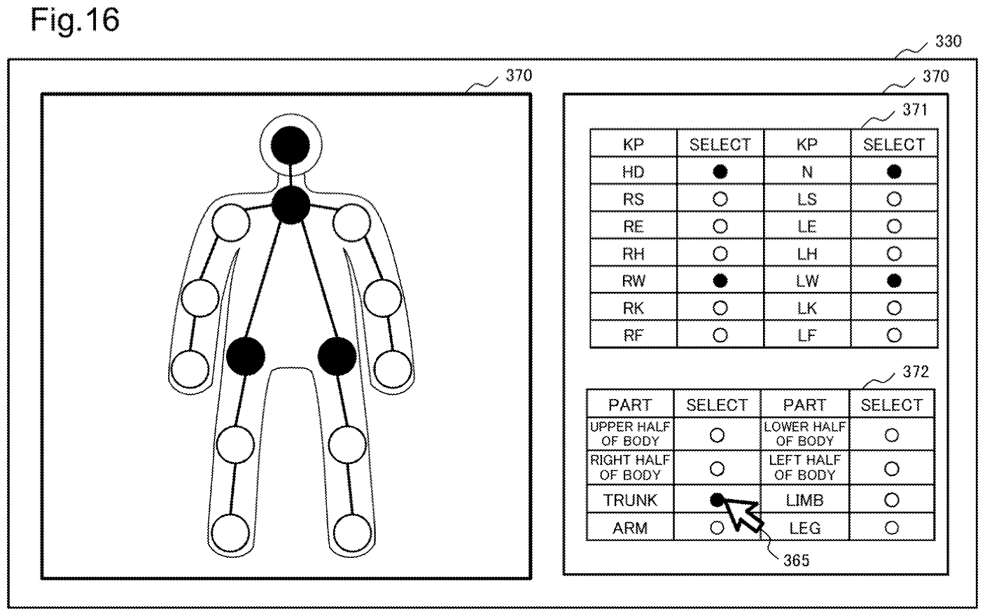

FIG. 16 is a conceptual diagram for explaining still another example of the display information displayed on the screen of the display equipment 330. The example of FIG. 16 is an example in which a “trunk” is selected in the collective designation image 372 in response to the operation of the pointer 365 via the terminal apparatus 320. When the “trunk” is selected in the collective designation image 372, the head (HD), the neck (N), the right waist (RW), and the left waist (LW) are collectively designated. In the example of FIG. 16, the key points of the “trunk” designated in the collective designation image 372 are displayed in the key point designation region 380. The selected key points are displayed in black in the key point designation region 370. For example, since both hands and both feet have a larger change between frames than the trunk has, if the weight is too large, there is a possibility that the tracking accuracy is deteriorated. Therefore, the weights of both hands and both feet may be set smaller by default than the weight of the trunk.

For example, when “upper half of body” is selected, the head (HD), the neck (N), the right shoulder (RS), the left shoulder (LS), the right elbow (RE), the left elbow (LE), the right hand (RH), and the left hand (LH) are collectively designated. For example, when “lower half of body” is selected, the right waist (RW), the left waist (LW), the right knee (RK), the left knee (LK), the right foot (RF), and the left foot (LF) are collectively designated. For example, when “right half of body” is selected, the right shoulder (RS), the right elbow (RE), the right hand (RH), the right knee (RK), and the right foot (RF) are collectively designated. For example, when “left half of body” is selected, the left shoulder (LS), the left elbow (LE), the left hand (LH), the left knee (LK), and the left foot (LF) are collectively designated. For example, when “limb” is selected, the right elbow (RE), the left elbow (LE), the right hand (HR), the left hand (LH), the right knee (RK), the left knee (LK), the right foot (RF), and the left foot (LF) are collectively designated. For example, when “arm” is selected, the right elbow (RE), the left elbow (LE), the right hand (RH), and the left hand (LH) are collectively designated. For example, when “foot” is selected, the right knee (RK), the left knee (LK), the right foot (RF), and the left foot (LF) re collectively designated.

For example, the weight of a selected key point is set to 1, and the weight of an unselected key point is set to 0. For example, when the upper half of body is selected, the weight of the key point included in the upper half of body is set to 1. For example, when the upper half of body is selected, the weight of the key point included in the upper half of body may be set to 1, and the weight of the key point included in the lower half of body may be set to 0.5.

The key points collectively selected when selected in the collective designation image 372 as described above are an example, and may be a combination different from the above. For example, instead of collectively selecting key points depending on the body part, an appropriate set of key points according to a scene or a situation may be prepared in advance so that the set of those key points can be intuitively selected. For example, a skilled user may cause a model to learn key points selected according to a scene or a situation, and the model may be used to estimate an appropriate key point according to the scene or the situation. For example, question items for setting the key points may be prepared, and the key points may be set according to the answers to the question items. When a set of key points prepared in advance can be selected, even an unskilled user who can individually select key points according to a scene or a situation can select an appropriate key point similarly to a skilled user.

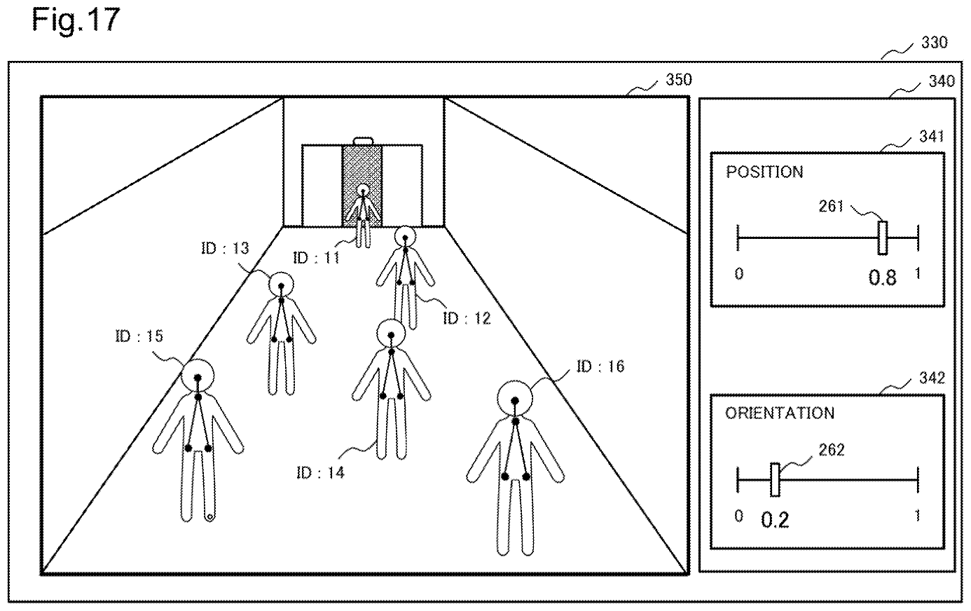

FIG. 17 is an example in which the tracking information is displayed in association with the person detected from the frame in a state where the “trunk” is selected and the head (HD), the neck (N), the right waist (RW), and the left waist (LW) are collectively designated as in FIG. 16. In the tracking information, four key points (HD, N, RW, and LW) extracted from the person detected from the frame and the line segments (skeleton lines) connecting those key points are displayed in association with the person. As in FIG. 17, in a case where the tracked target moves in the same orientation, it is sufficient if the position of the tracked target can be grasped, and thus the tracking is only required to be performed with emphasis on the key point of the trunk, which moves relatively little. For example, the display information of FIGS. 15 to 16 and the display information of FIG. 17 are only required to be switched by pressing of a button not illustrated that is displayed on the screen of the display equipment 330.

### Operation

Next, an example of the operation of the tracking apparatus 30 will be described with reference to the drawings. Since the outline of the processing by the tracking apparatus 30 is similar to that of the first example embodiment, it is omitted. Hereinafter, details of the tracking processing by the tracking unit 37 of the tracking apparatus 30 will be described. For example, it is inserted in any of steps S13 and S14 in FIG. 5. The setting processing is executed in accordance with designation of key points and adjustment of weights of the position and the orientation.

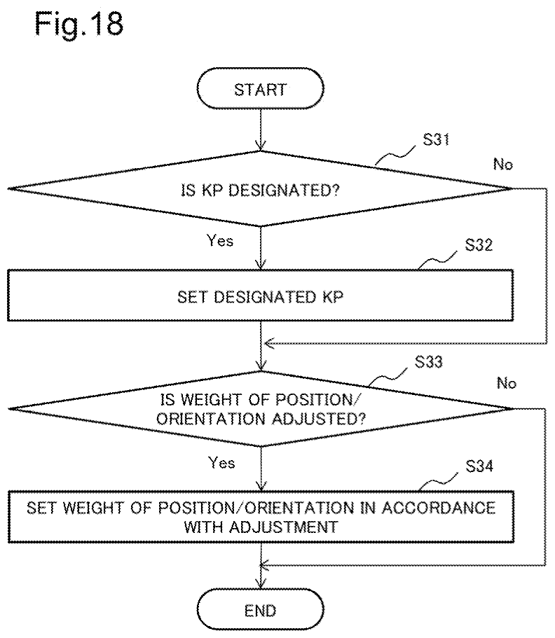

In FIG. 18, first, the tracking apparatus 30 determines whether a key point (KP) is designated (step S31). If the key point is designated (Yes in step S31), the tracking apparatus 30 sets the designated key point as an extraction target (step S32). On the other hand, if the key point is not designated (No in step S31), the process proceeds to step S33.

Next, if the weights of the position and the orientation are adjusted (Yes in step S33), the tracking apparatus 30 sets the weights of the position and the orientation in accordance with the adjustment (step S34). After step S34, the process proceeds to the subsequent processing in the flowchart of FIG. 5. If the weights of the position and the orientation are not adjusted (No in step S33), the process proceeds to the subsequent processing in the flowchart of FIG. 5 without readjusting the weights of the position and the orientation.

As described above, the tracking system of the present example embodiment includes the surveillance camera, the tracking apparatus, and the terminal apparatus. The surveillance camera captures an image of a surveillance target range and generates video data. The terminal apparatus is connected to the display equipment having a screen for displaying the display information generated by the tracking apparatus. The tracking apparatus includes the video acquisition unit, the storage unit, the detection unit, the extraction unit, the posture information generation unit, the tracking unit, the tracking information output unit, and the setting acquisition unit. The video acquisition unit acquires video data from the surveillance camera. The storage unit stores the acquired video data. The detection unit detects the tracked target from at least two frames constituting the video data. The extraction unit extracts at least one key point from the detected tracked target. The posture information generation unit generates posture information of the tracked target based on the at least one key point. The tracking unit tracks the tracked target based on the position and the orientation of the posture information of the tracked target detected from each of the at least two frames. The tracking information output unit outputs, to the terminal apparatus, tracking information related to tracking of the tracked target. The setting acquisition unit acquires a setting input using the terminal apparatus. The setting acquisition unit acquires setting of weights related to the position and the orientation, setting of key points, and the like. The setting acquisition unit reflects the acquired setting in the function of the tracking apparatus.

In the present example embodiment, the terminal apparatus sets the image display region and the weight setting region on the screen of the display equipment. In the image display region, a tracking image is displayed in which a key point is associated with the tracked target detected from the frame constituting the video data. In the weight setting region, an operation image for setting the weight related to the position and the weight related to the orientation is displayed. The terminal apparatus outputs, to the tracking apparatus, the weight related to the position and the weight related to the orientation set in the weight setting region. The tracking apparatus acquires, from the terminal apparatus, the weight related to the position and the weight related to the orientation selected in the weight setting region. Using the weight related to the position and the weight related to the orientation having been acquired, the tracking apparatus calculates a score in accordance with the distance regarding the position and the orientation related to the tracked target detected from each of at least two frames constituting the video data. The tracking apparatus tracks the tracked target based on the calculated score.

In the present example embodiment, the weights related to the position and the orientation can be discretionarily adjusted in response to the user operation. Therefore, according to the present example embodiment, it is possible to achieve tracking of the tracked target with high accuracy based on the weight in accordance with a user request.

In one aspect of the present example embodiment, the terminal apparatus causes the weight setting region to display, according to the scene, an operation image for setting the weight related to the position and the weight related to the orientation. The terminal apparatus outputs, to the tracking apparatus, the weight related to the position and the weight related to the orientation according to the scene set in the weight setting region. According to the present aspect, it is possible to discretionarily adjust the weights related to the position and the orientation according to the scene. Therefore, according to the present example embodiment, it is possible to achieve highly accurate tracking of the tracked target suitable for the scene.

In one aspect of the present example embodiment, the terminal apparatus sets, on the screen of the display equipment, a key point designation region in which the designated image for designating the key point to be used for generation of the posture information of the tracked target is displayed. The terminal apparatus outputs, to the tracking apparatus, the key point selected in the key point region. The tracking apparatus acquires, from the terminal apparatus, the key point selected in the key point selection region. The tracking apparatus generates posture information regarding the acquired key point. In the present aspect, the key point used to generate the posture information can be discretionarily adjusted in response to the user operation. Therefore, according to the present example embodiment, it is possible to achieve tracking of the tracked target with high accuracy by using the posture information in accordance with a user request.

### Fourth Example Embodiment

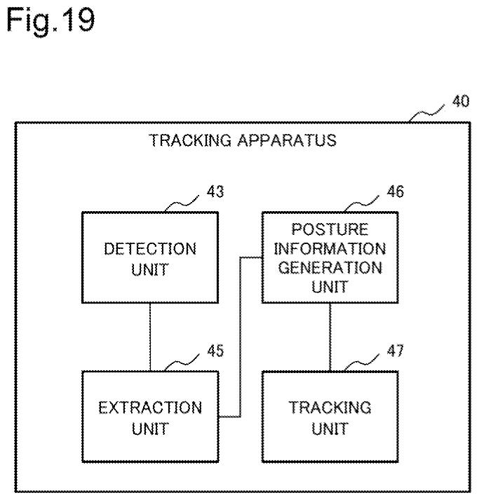

Next, the tracking apparatus according to the fourth example embodiment will be described with reference to the drawings. The tracking apparatus of the present example embodiment has a configuration of simplified tracking apparatuses of the first to third example embodiments. FIG. 19 is a block diagram illustrating an example of the configuration of the tracking apparatus 40 of the present example embodiment. The tracking apparatus 40 includes a detection unit 43, an extraction unit 45, a posture information generation unit 46, and a tracking unit 47.

The detection unit 43 detects the tracked target from at least two frames constituting the video data. The extraction unit 45 extracts at least one key point from a detected tracked target. The posture information generation unit 46 generates posture information of the tracked target based on the at least one key point. The tracking unit 47 tracks the tracked target based on the position and the orientation of the posture information of the tracked target detected from each of at least two frames.

As described above, by tracking the tracked target based on the position and the orientation of posture information of the tracked target, the tracking apparatus of the present example embodiment can track a plurality of tracked targets based on postures in a frame constituting a video.

### Hardware

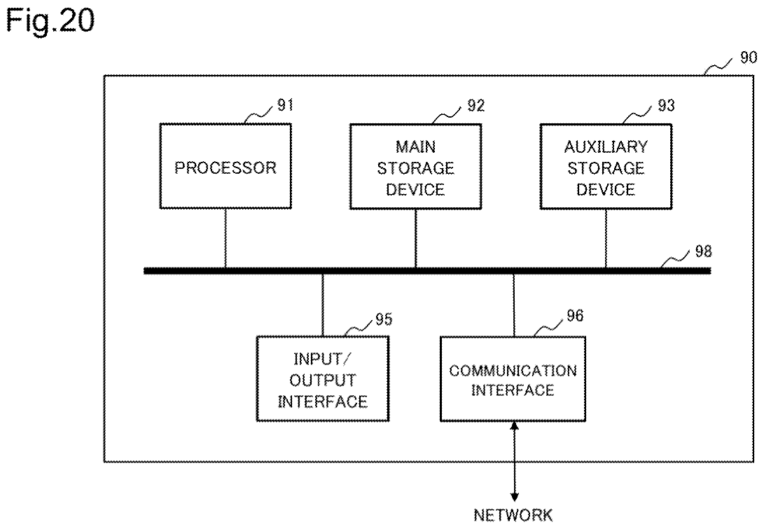

Here, a hardware configuration for executing processing of the tracking apparatus, the terminal apparatus, and the like (hereinafter, called the tracking apparatus and the like) according to each example embodiment of the present disclosure will be described using an information processing apparatus 90 of FIG. 20 as an example. The information processing apparatus 90 in FIG. 20 is a configuration example for executing processing of the tracking apparatus and the like of each example embodiment, and does not limit the scope of the present disclosure.

As in FIG. 20, the information processing apparatus 90 includes a processor 91, a main storage device 92, an auxiliary storage device 93, an input/output interface 95, and a communication interface 96. In FIG. 20, interface is abbreviated as I/F. The processor 91, the main storage device 92, the auxiliary storage device 93, the input/output interface 95, and the communication interface 96 are connected to be capable of data communication with one another via a bus 98. The processor 91, the main storage device 92, the auxiliary storage device 93, and the input/output interface 95 are connected to a network such as the Internet or an intranet via the communication interface 96.

The processor 91 develops a program stored in the auxiliary storage device 93 or the like into the main storage device 92 and executes the developed program. The present example embodiment is only required to have a configuration of using a software program installed in the information processing apparatus 90. The processor 91 executes processing by the tracking apparatus and the like according to the present example embodiment.

The main storage device 92 has a region where the program is developed. The main storage device 92 is only required to be a volatile memory such as a dynamic random access memory (DRAM), for example. A nonvolatile memory such as a magnetoresistive random access memory (MRAM) may be configured as and added to the main storage device 92.

The auxiliary storage device 93 stores various data. The auxiliary storage device 93 includes a local disk such as a hard disk or a flash memory. Various data can be stored in the main storage device 92, and the auxiliary storage device 93 can be omitted.

The input/output interface 95 is an interface for connecting the information processing apparatus 90 and peripheral equipment. The communication interface 96 is an interface for connecting to an external system and apparatus through a network such as the Internet or an intranet based on a standard or specifications. The input/output interface 95 and the communication interface 96 may be shared as an interface connected to external equipment.

The information processing apparatus 90 may be configured to be connected with input equipment such as a keyboard, a mouse, and a touchscreen as necessary. Those pieces of input equipment are used to input information and settings. In a case of using a touchscreen as input equipment, the display screen of display equipment is only required to serve also as an interface of the input equipment. Data communication between the processor 91 and the input equipment is only required to be mediated by the input/output interface 95.

The information processing apparatus 90 may include display equipment for displaying information. In a case of including display equipment, the information processing apparatus 90 preferably includes a display control apparatus (not illustrated) for controlling display of the display equipment. The display equipment is only required to be connected to the information processing apparatus 90 via the input/output interface 95.

The information processing apparatus 90 may be provided with a drive apparatus. The drive apparatus mediates reading of data and a program from a recording medium, writing of a processing result of the information processing apparatus 90 to the recording medium, and the like between the processor 91 and the recording medium (program recording medium). The drive apparatus is only required to be connected to the information processing apparatus 90 via the input/output interface 95.

The above is an example of the hardware configuration for enabling the tracking apparatus and the like according to each example embodiment of the present invention. The hardware configuration of FIG. 20 is an example of a hardware configuration for executing arithmetic processing of the tracking apparatus and the like according to each example embodiment, and does not limit the scope of the present invention. A program for causing a computer to execute processing related to the tracking apparatus and the like according to each example embodiment is also included in the scope of the present invention. Furthermore, a program recording medium recording a program according to each example embodiment is also included in the scope of the present invention. The recording medium can be achieved by an optical recording medium such as a compact disc (CD) or a digital versatile disc (DVD), for example. The recording medium may be achieved by a semiconductor recording medium such as a universal serial bus (USB) memory or a secure digital (SD) card, a magnetic recording medium such as a flexible disk, or another recording medium. When a program executed by the processor is recorded in a recording medium, the recording medium corresponds to a program recording medium.

The constituent elements such as the tracking apparatus of each example embodiment can be discretionarily combined. The constituent elements such as the tracking apparatus of each example embodiment may be achieved by software or may be achieved by a circuit.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1, 2, 3 tracking system
10, 20, 30, 40 tracking apparatus
11, 21, 31 video acquisition unit
12, 22, 32 storage unit
13, 23, 33, 43 detection unit
15, 25, 35, 45 extraction unit
16, 26, 36, 46 posture information generation unit
17, 27, 37, 47 tracking unit
18, 28, 38 tracking information output unit
39 setting acquisition unit
110, 210, 310 surveillance camera
120, 220, 320 terminal apparatus
321 tracking information acquisition unit
322 tracking information storage unit
323 display unit
324 input unit
327 input equipment
330 display equipment

What is claimed is:

1. A tracking apparatus comprising:
at least one memory storing instructions; and
at least one processor connected to the at least one memory and configured to execute the instructions to:
detect a tracked target from at least two frames constituting video data;
extract at least one key point from the tracked target having been detected;
generate posture information of the tracked target based on the at least one key point; and
track the tracked target based on a position and an orientation of the posture information of the tracked target detected from each of the at least two frames.

2. The tracking apparatus according to claim 1, wherein
the at least one processor is configured to execute the instructions to
calculate, based on the posture information, a score in accordance with a distance regarding a position and an orientation related to the tracked target detected from each of the at least two frames, and
track the tracked target based on the score having been calculated.

3. The tracking apparatus according to claim 2, wherein
the at least one processor is configured to execute the instructions to
tracking, as the tracked target that is identical, a pair having the score that is minimum, regarding the tracked target detected from each of the at least two frames.

4. The tracking apparatus according to claim 2, wherein
the at least one processor is configured to execute the instructions to
calculate, as a distance regarding the position, a weighted mean of absolute values of differences in coordinate values of the key point regarding the tracked target detected from each of the at least two frames,
calculate, as a distance regarding the orientation, a weighted mean of absolute values of differences in relative coordinate values in a specific direction with respect to a reference point of the key point, and
calculate, as the score, a sum of the distance regarding the position and the distance regarding the orientation.

5. The tracking apparatus according to claim 2, wherein
the at least one processor is configured to execute the instructions to
estimate a number of height pixels of the tracked target based on a skeleton line connecting any of a plurality of the key points,
normalize the score with the number of height pixels having been estimated, and
track the tracked target detected from each of the at least two frames in accordance with the score having been normalized.

6. A tracking system comprising:
the tracking apparatus according to claim 1;
a surveillance camera that captures an image of a surveillance target range and generates video data; and
a terminal apparatus connected to display equipment having a screen for displaying display information generated by the tracking apparatus.

7. The tracking system according to claim 6, wherein
the terminal apparatus comprises at least one memory storing instructions, and
at least one processor connected to the at least one memory and configured to execute the instructions to
set, onto a screen of the display equipment, an image display region where a tracking image in which a key point is associated with a tracked target detected from a frame constituting the video data is displayed, and a weight setting region where an operation image for setting a weight related to a position and a weight related to an orientation is displayed, and
output, to the tracking apparatus, the weight related to the position and the weight related to the orientation set in the weight setting region, and
at least one processor of the tracking apparatus is configured to execute the instructions to
acquire, from the terminal apparatus, the weight related to the position and the weight related to the orientation selected in the weight setting region, and
calculate, using the weight related to the position and the weight related to the orientation having been acquired, a score in accordance with a distance regarding a position and an orientation related to the tracked target detected from each of at least two frames constituting the video data, and
track the tracked target based on the score having been calculated.

8. The tracking system according to claim 6, wherein
the at least one processor of the terminal apparatus is configured to execute the instructions to
set, onto a screen of the display equipment, a key point designation region where a designation image for designating a key point used to generate posture information of the tracked target is displayed, and
output, to the tracking apparatus, the key points selected in the key point designation region, and
the at least one processor of the tracking apparatus is configured to execute the instructions to
acquire, from the terminal apparatus, the key point selected in the key point designation region, and
generate the posture information regarding the key point having been acquired.

9. A tracking method by a computer, the method comprising:
detecting a tracked target from at least two frames constituting video data,
extracting at least one key point from the tracked target having been detected,
generating posture information of the tracked target based on the at least one key point, and
tracking the tracked target based on a position and an orientation of the posture information of the tracked target detected from each of the at least two frames.

10. A non-transitory program recording medium recording a program that causes a computer to execute
processing of detecting a tracked target from at least two frames constituting video data,
processing of extracting at least one key point from the tracked target having been detected,
processing of generating posture information of the tracked target based on the at least one key point, and
processing of tracking the tracked target based on a position and an orientation of the posture information of the tracked target detected from each of the at least two frames.
